(19) United States
(12) Patent Application Publication
(10) Pub. No.: US 2003/0021915 A1
(43) Pub. Date: Jan. 30, 2003

(54) Cellulose - polymer composites and related manufacturing methods

(76) Inventors: Vivek Rohatgi, Cincinnati, OH (US); Ashok M. Adur, Cincinnati, OH (US); Keith S. Shih, Loveland, OH (US); Maged Botros, West Chester, OH (US); Richard Previty, Milford, OH (US); Gregory James Castle, Wilder, KY (US)

Correspondence Address: OSTRAGER CHONG & FLAHERTY LLP, 825 THIRD AVE, 30TH FLOOR, NEW YORK, NY, 10022-7519, US

(21) Appl. No.: 10/172,520

(22) Filed: Jun. 14, 2002

Related U.S. Application Data
(60) Provisional application No. 60/298,477, filed on Jun. 15, 2001.

(51) Int. Cl. A01N 1/00; B29C 47/90

(52) U.S. Cl. 428/15; 264/211.23; 264/75; 264/54

(57) ABSTRACT

Cellulose-polymer composites characterized by the cellulose component being thoroughly encapsulated by the polymer component, varying density which allows high strength over a wide range of temperatures and generally low weight are provided. Composites may be extruded or coextruded into a variety of products including wood-like decking materials with natural wood coloring and texture. Processes related to the manufacture of the composites are also provided.

### FIELD OF THE INVENTION

This invention generally relates to composites comprising cellulosic fiber and thermoplastic polymers and methods related to the manufacturing of the composites. More particularly, the invention relates to various products formed from the composites, including wood-like boards and molded materials which have enhanced strength at a wide range of temperatures and yet are relatively low density and light weight.

### BACKGROUND OF THE INVENTION

It is known that artificial wood-like products can be made from combinations that include wood and plastics. Such processes, in general, consist of forming a mixture of thermoplastic resins, various additives and a variety of fibrous ingredients including recycled wood scrap such as waste cellulosic fiber, saw dust and pulp. These products make use of some of the waste cellulosic material that results from the production of other articles in the wood, paper and other industries.

One example of a process for the production of artificial wood comprises mixing a thermoplastic resin, such as polyethylene or polypropylene, with ground or fibrous material obtained from sawdust, waste paper, newspaper, corrugated board or compressed board paper which has been shredded or ground and kneading the mixture in a heated batch mixer. The kneading process generates additional heat by the friction and shear generated in the mixer, vaporizing any moisture in the cellulosic material. Such techniques are disadvantageous in that the resin and the cellulosic material are generally not uniformly dispersed in the composition and fiber degradation often results due to the localized regions of high temperatures and shear from the manufacturing process. Moreover, many cellulosic-plastic composite products made with such a process are of relatively low quality or are inappropriate for certain applications because they are weaker or heavier than natural wood, have surface imperfections such as cracks or blows, and do not have sufficient modulus or compressive strength or a coefficient of thermal expansion to match wood. Further, these composites may not have the physical properties of wood, such as hardness and rigidity that permits sawing, milling and fastener retention.

In addition, companies that make such products are becoming increasingly sensitive to waste streams produced in their manufacture. Such waste streams may contain substantial quantities of waste wood, but are often also contaminated with substantial proportions of hot melt and solvent-based adhesives, waste thermoplastics such as polyvinyl chloride, polyethylene, paint, preservatives, and other organic materials. Commonly, these materials are either burned for their heat value in electrical generation or are shipped to qualified landfills for disposal. Because of such contamination problems, manufacturers are often required to find other means for disposing of the waste, at a significant expense. A substantial need exists to find a productive, environmentally friendly process for using such waste streams.

Another known method is to mix the wood flour at about 1 percent moisture, polymer, and additives in a ribbon blender. The blend is conveyed pneumatically to a crammer feeder. This forces the blend into the feed section of the twin-screw conical counter rotating extruder. The extruder then discharges the molten mixture through a profile die. The key to the process is the die that is designed to form strands of material, which are then combined in the final shaping die, resulting in a product with a wood grain effect. It is thought that this design reduces the pressure requirements for manufacturing wood-like grained product. A variant of the system has two vents within the extruder to increase the range of wood flour moistures over which the process can operate and a more conventional die design. Some disadvantages of using this method of manufacture include a) an inconsistent transfer of materials from a ribbon blender caused by segregation of the blended materials which can result in a product with variable properties, b) the use of a counter rotating conical extruder which is not as good a mixer as the co-rotating twin screw, which can result in process instability and inconsistent product quality, and c) no provision in the arrangement to add a separate color to produce wood-like two-tone color and/or a wood grain effect. There is evidence that stranding technology results in products with ‘spot weld’, i.e. point of weakness, between the fibers. The overall physical properties of the compositions are not very good for their intended use as wood substitutes. For example, some ‘unraveling’, occurs when the product is cut, milled or grooved. Such systems also have output rate limitations and are inherently inflexible.

It is also known that a cellulose-polymer composite can be given a wood graining effect. But this effect is added at the end of the manufacturing process and involves surface abrasion and printing. This method of graining is complex, offline, expensive and limited to the outer surfaces of the composite.

Accordingly, it is an object of the invention to provide composite that can be made of polymer and cellulose fiber by an extrusion and coextrusion processes and which has all the aesthetic attributes of natural wood, such as grain, texture and two-tone color, but is better in performance than existing composites or natural wood in terms of splitting, checking, warping, insect/rot resistance and moisture absorption. In order to be suitable for building materials, the composite will ideally be extrudable into shaped structures having reproducible, stable dimensions and possess a high tensile, flexural and compressive strength, a low coefficient of thermal expansion, a low thermal transmission rate, an improved resistance to insect attack and rot, and a hardness and rigidity that permits sawing, milling, and fastener retention comparable to natural wood products.

Another object of the invention is to provide a composite product having the aforementioned qualities, which may be produced with recycled materials.

### SUMMARY OF THE INVENTION

In the present invention, these purpose, as well as others, which will be apparent, are achieved generally by providing a composite comprising cellulosic fiber and polymers and methods related to the manufacturing of the composites. Preferred embodiments of these composites include low weight/low density, high strength products which maintain their strength over a wide range of temperatures. The composites are further characterized by their structure, which generally comprises cellulosic fibers completely encapsulated by the polymer component.

In some preferred embodiments the composites are characterized as having a generally inner portion, which has a high cellulosic fiber to polymer ratio, and a generally outer portion, which has a low cellulosic fiber to polymer ratio. Densities may vary by as much as 0.39 grams per cubic centimeter or more in an extruded product. This structure contributes to the strength characteristics and, in embodiments which may include wood-like boards or decking materials, results in a product which is useful in construction applications because it has high fastener retention, high hardness characteristics and other qualities similar to, or improved over, those of natural wood.

In some preferred embodiments the composites are characterized as having a core layer comprises of 50-60 wt. % filler and a capstock with 10-30 wt % filer.

Some embodiments of the invention may further be characterized by their wood grain-like or “streaking” appearance, both in coloring and three-dimensional surface texture.

In one preferred embodiment products may be produced by combining about 50-70 weight percent cellulosic material at mesh sizes between about 10 and 200, moisture levels as high as 4 to 10 percent and bulk densities between about 8 to 25 pounds per cubic foot; about 16.5 to 50 weight percent polymer resins; and other ingredients which may include compatibilizers, 0.25 to 3 percent; process aids, 0.5 to 2 percent; foaming agents, up to about 1.5 percent; base coloring agents, up to about 4 percent; UV inhibitors, up to about 1 percent; grain coloring agents, up to about 3 percent; and a variety of other additives to affect flame retardancy, insect repellency and other attributes.

One preferred process for producing the composites may include adding the cellulosic material into a twin screw extruding apparatus and extruding the material while venting off moisture; adding the polymer material, compatiblizer and other ingredients and extruding the mixture; adding graining color agents near the end of the twin screw extruder and extruding the mixture; transferring the mixture under vacuum to remove remaining volatiles to a single screw extruding apparatus; extruding the mixture and forcing it through a plurality of dies; calibrating, cooling, embossing and cutting the extrudate in a manner appropriate to its final use.

A preferred process for producing the composite material having a core layer comprises of 50-60 wt. % filler and a capstock with 10-30 wt % filer might include adding the cellulosic material and other ingredients into a first extruder; adding graining color agents near the end of the twin screw extruder; venting the cellulosic material during extruding; adding polymer material to form a cellulosic material-polymer material mixture; extruding the cellulose material-polymer material mixture; repeating the above steps through a second extruder that is combined with the first extruder in a combining adaptor or feedstock; forcing the cellulose material-polymer material mixture through a die to form an coextrudate material with skin and core having different attributes; calibrating the extrudate; and cooling the extrudate to form a polymer cellulose composite.

Other preferred processes for converting the composites into finished articles include compression molding, thermoforming, hot stamping injection blow molding and/or injection molding comprising of filler content in the range of 30%-90%, more preferably in the range of 50-75%,

Embodiments of the invention may include wood-like boards, panels or sheets produced by an extrusion process and molded articles, which may be produced at the end of the extrusion line or extruded or injection molded from composite pellets produced during the initial process.

The invention may incorporate a wide variety of waste cellulosic and polymeric materials including but not limited to waste poly-coated paper and paperboard and includes methods for reducing hazards and the production of harmful waste during the manufacturing process.

Other objects, features and advantages of the present invention will be apparent when the detailed description of the preferred embodiments are considered in conjunction with the drawings which should be construed in an illustrative and not limiting sense, as follows:

### BRIEF DESCRIPTION OF THE DRAWINGS

FIG. 1(a) is a schematic showing a preferred extrusion and mixing process of the invention.

FIG. 1(b) is a schematic showing a preferred calibration, cooling and embossing process of the invention.

FIG. 2 is a perspective view of a preferred embodiment of the invention showing density variations across the composite's cross section.

FIG. 3 is a perspective view of another preferred embodiment of the invention showing wood grain coloring and texture.

FIG. 4 is a photomicrograph showing a portion of a cross-sectional slice of a preferred embodiment of the invention, viewing an area near an outer edge of the cross section at 300× magnification, which shows encapsulation of cellulosic material by polymeric material.

FIG. 5 is a photomicrograph showing a portion of a cross-sectional slice of a preferred embodiment of the invention, viewing an area near a central portion of the cross section at 300× magnification, which shows encapsulation of cellulosic material by polymeric material.

FIG. 6 is a photomicrograph of a portion of a cross-sectional slice of a prior art product at 100× magnification, which shows cellulosic material, which is not fully encapsulated by polymeric material.

FIG. 7 is a graph comparing the modulus of elasticity vs. temperature of several sample and commercially available products.

FIG. 8 is a graph comparing the force required to withdraw a nail from several sample and commercially available products.

FIG. 9 is a graph comparing the static coefficient of friction of a sample product as compared to commercially available products.

FIG. 10 is a schematic showing a preferred single screw colorant extruder.

### DETAILED DESCRIPTION OF THE PREFERRED EMBODIMENTS

The present invention relates to composites comprising cellulosic material and thermoplastic polymers and methods related to the manufacturing of composites that have high strength, low density, and other characteristics.

A preferred process and apparatus arrangement may be described by the following example. The process generally includes two phases. The first phase includes mixing the ingredients and extruding the mixture, and the second phase includes calibrating, cooling and, optionally, embossing the extrudate.

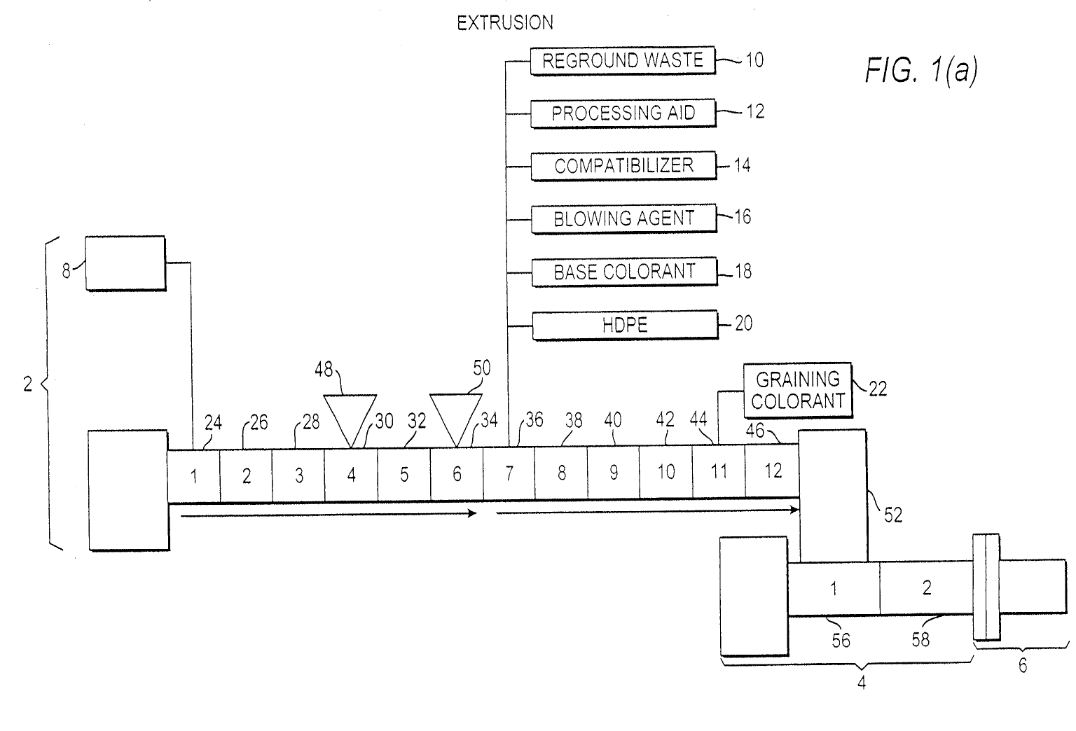

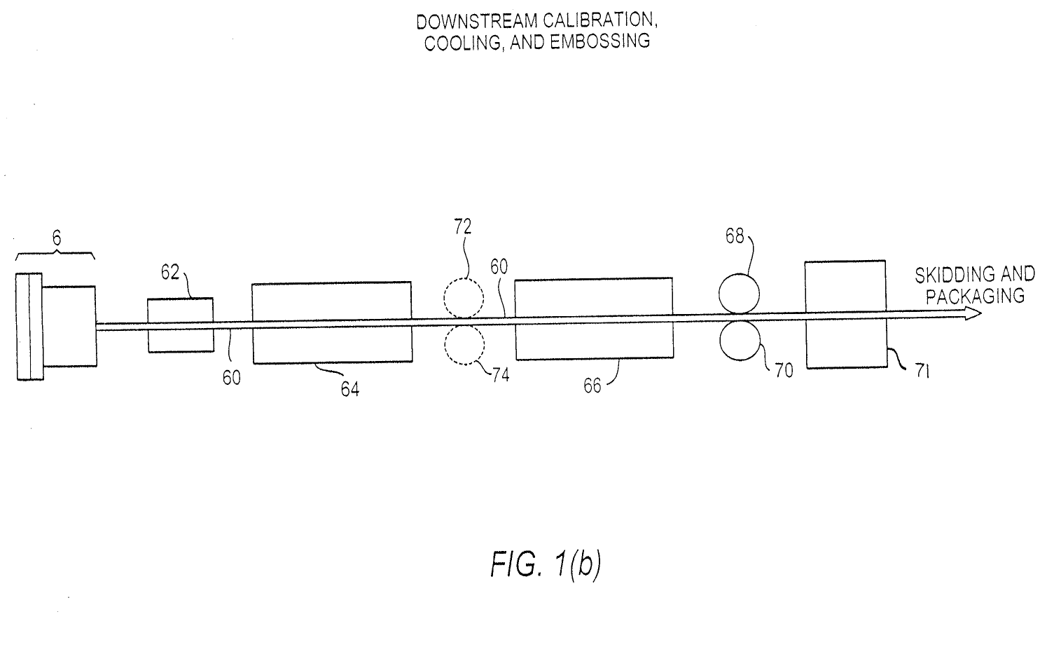

Referring to FIG. 1(a), the first phase consists of a 58 mm co-rotating (ZSK 58MC®) (Coperion-Ramsey, N.J.) twin-screw extruder 2 for drying, compounding, mixing and heating the cellulosic fiber, polymer and compatibilizer (Compatibilizers are chemicals with functional groups capable of forming covalent bonds with the O—H groups in the cellulosic fibers.), and a 6.0 inch, 12:1 L/D water cooled single screw extruder (ESA 150®) (Merritt Extruder-Hamden, Conn.) 4 with a single flighted screw to pump the molten mixture through a forming die 6. Loss in weight feeders 8, 10, 12, 14, 16, 18, 20, 22 meter each component into the process at the required mass flow rate.

The twin-screw extruder 2 comprises one pair of splined screw shaft couplings, which run through twelve barrel sections 24, 26, 28, 30, 32, 34, 36, 38, 40, 42, 44, and 46. The screw shaft is sealed between barrels with packing and a lantern ring. Each barrel section 24-46 is 240 mm long and has a steel thermocouple connection. The first barrel section 24 is water-cooled and the remaining eleven-barrel sections 26-46 are temperature controlled with resistance heaters and water-cooling.

In this example, cellulosic material in the form of wood flour is the first component to be fed into the twin-screw extruder 2. It is metered into the barrel section 24. The first six barrel section 24-34 temperatures are set in such a manner as to drive most of the moisture out of the wood flour. The moisture evaporates out of the extruder from two vent ports 48, 50 located at barrel sections 30 and 34. The screw elements in the first six-barrel sections 24-34 are for conveying and are low shearing.

The HDPE (high density polyethylene) along with other additives including the foaming agent, processing aid, compatibilizer, reground waste, base color and UV inhibitor (which may be added separately or may be incorporated into the base color), are metered into barrel section 36 with a side feeder (not shown) which is attached to the loss in weight feeders 10-20. The last six barrel sections 36-46 are for high shearing and kneading. The ingredients added to barrel section 36 become molten as they are heated and mix thoroughly with the dried wood flour as the ingredients are conveyed through barrel sections 36-46. At barrel section 44 the graining colorant is metered from loss in weight feeder 22 into the twin-screw extruder 2. The effect of the shearing and kneading elements on the graining colorant is lower than the effect on the other ingredients because the graining colorant is added relatively late in the mixing process. The relatively low shearing/kneading action and the melt flow characteristics of the graining colorant result in a visual wood graining effect in the final product. The molten mixture discharges from the twin-screw extruder 2 into a single screw extruder 4 (which is comprised of single screw barrel sections 56 and 58) that pumps the molten mixture through a profile die 6. The profile die 6 accepts the flow of material from the single screw extruder 4 and alters its shape so that the extrudate is essentially rectangular with substantially flat sides when it exits the die. The die itself is approximately 5″-7″ in length, and has an aggressive transition of about 3″-5″ and a short final land of about 2″. The transition is the portion of the die that accepts extruded material from the extruder and essentially conforms it from a cylindrical to a rectangular shape. The land maintains a constant rectangular shape. Extrudates made by this process are generally free from melt fractures and melt instability problems. The die may or may not have torpedo restrictors (not shown) in the transition area from the extruder. During the process of being forced through the die the mixture is compressed before exiting as an extrudate. The transition area 52 from twin screw to single screw is a liquid ring vacuum unit (kept under vacuum of, e.g. −5″ to −30″ Hg). This unit removes additional volatiles, including moisture, as the mixture enters the single screw extruder. The moisture content of the mixture as it enters the single screw extruder 4 is generally less than 2 percent, as measured by the Karl Fischer titration technique.

The next phase includes calibration, cooling and embossing. Referring to FIG. 1(b), which shows the continuation of the process which starts in FIG. 1(a), as the extrudate 60 exits the profile die 6, it enters the calibration sizing tooling area 62 where it is sized to its final dimensions using a vacuum and cooling water. The cross-sectional area of the profile die 6 opening is less than the cross-sectional area of the final size of the calibration sizing tooling area 62 and final product. As the extrudate exits the calibration sizing tooling area 62 the foaming agent causes it to expand. This increases the extrudate dimensions and reduces the density of the final product. The carbon dioxide generated from the foaming agent also serves as a process aid to smoothen the surface of the final product. The extrudate maintains its rectangular shape during this expansion.

The extrudate 60 is then conveyed through a 30-foot long Super Quench®(ESI, Akron, Ohio) spray cooling tank with support rollers 64 to quench (cool) the product. The number of additional spray cooling tanks 66 required is dependent upon total extrusion output rate and the residence time required to fully quench (cool) the product.

After exiting the final cooling tank 66 a wood-like surface texture may be applied by heated embossing rolls 68, 70 to both the top and bottom of the extrudate 60 surface. The embossing roll location may be placed at a location after the first cooling tank as shown by reference numerals 72 and 74, depending upon the desired embossing pattern.

After the extrudate is cooled and embossed it may be cut to any desired length. The extrudate is then inspected and forwarded to an automated stacking system. The extrudate, in the form of boards or planks, may be grouped like lumber and allowed to cool to ambient temperature. Extrudates produced by the above process generally have smooth surfaces without melt fractures.

Table 1 shows exemplary combinations of cellulosic material, polymer, compatibilizer and other additives. Col. 1 shows preferred ranges of ingredients and Col 2 shows more preferred ranges. Col. 3 shows a most preferred range for a preferred embodiment wood-like decking product.

TABLE 1

| | FORMULATION | | |
|---|---|---|---|
| | Broad | Narrow | A Most Preferred Range |
| Ingredient | (col. 1) | (col. 2) | (col. 3) |
| Wood Fiber | | | |
| loading (wt. %) | 50-70 | 55-68 | 60.00 |
| Mesh size | 10-200 | 20-80 | 40-80; trace 20-30; |
| | | | trace finer than 80 |
| moisture (wt. % | 4-10 | 5-8 | 5.5-7.5 |
| of wood fiber) | | | |
| bulk density | 8-25 | 8-16 | 11-13 |
| (lb/ft³) | | | |
| Compatibilizer | 0.25-3.0 | 0.5-0.75 | 0.50 |
| (wt. %) | | | |
| Process aid | 0.5-2.0 | 1.0-1.5 | 1.50 |
| (wt. %) | | | |
| Foaming agent | 0-1.5 | 0.5-1.0 | 0.75 |
| (wt. %) | | | |
| Base color | 0-4.0 | 3.0-4.0 | 4.00 |
| (wt. %) | | | |
| UV inhibitor | 0-1.0 | 0.1-0.5 | 0.25 |
| (wt. %) | | | |
| Grain color | 0-3.0 | 1.0-2.0 | 1.00 |
| (wt. %) | | | |
| Polymer resin | 16.5-50 | 30.5-43.5 | 32.00 |
| (wt. %) | | | |

Table 2 shows the ingredients used in four Sample products manufactured by the process detailed above.

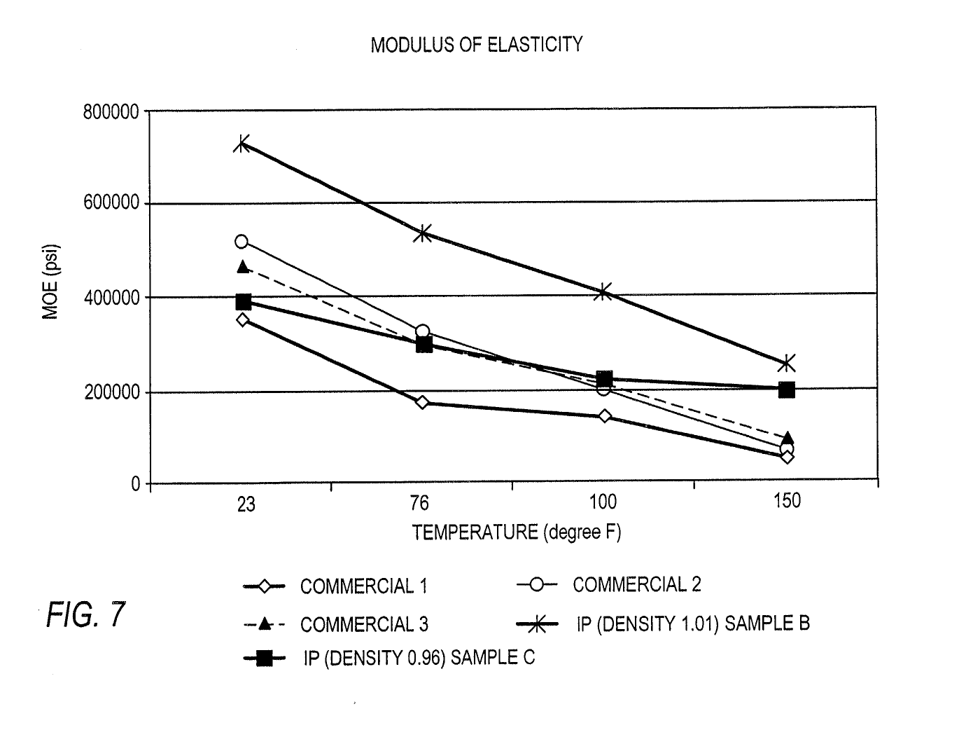

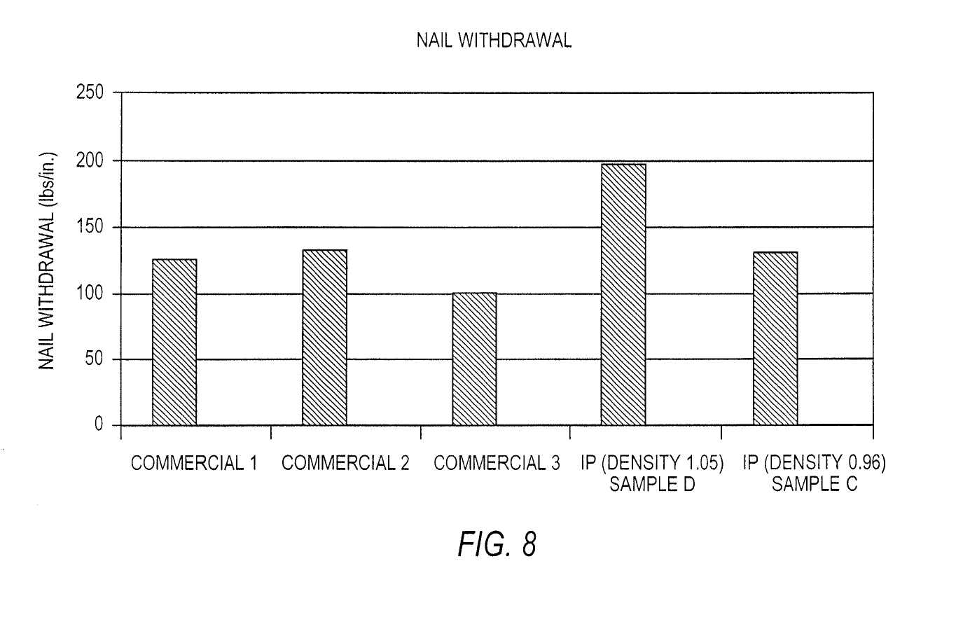

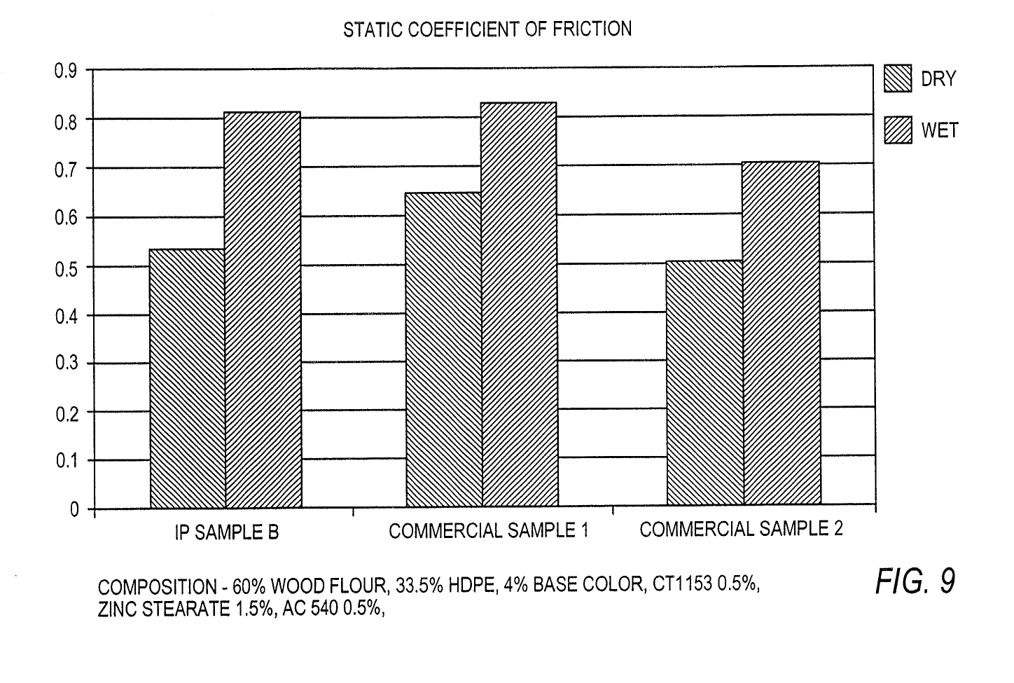

TABLE 2

| | |
|---|---|
| Sample A | |
| Wood Fiber | 60 (wt. %) (American Wood Fibers - |
| | Schofield, Wisconsin) (Pine flour) |
| Mesh size | 40-80; trace 20-30 and finer than 80 |
| Moisture (wt. %) | 5.5-7.5 |
| Bulk density (lb/ft³) | 11-13 |
| Compatibilizer (wt. %) | 0.50 (AC 540) |
| Process Aid (wt. %) | 1.50 (Zinc Stearate) |
| Foaming Agent (wt. %) | 0.75 (CT1153) (CT1401) |
| | (endothermic/exothermic) |
| | (Clariant - Winchester, VA) |
| Base Color (wt. %) | 4.00 (20 Melt Index (MI) linear low |
| | density polyethylene - LLDPE) (Penn |
| | Color - Hatfield, PA) |
| UV inhibitor (wt. %) | 0.25 (Ciba Tinuvin 791) |
| Grain color (wt. %) | 1.00 (Penn Color - Hatfield, PA) |
| Polymer resin (wt. %) | 32.00 (HDPE) (Chevron 9416, grade |
| | 0.7: Chevron - Houston, TX) |
| Sample B | |
| (Density 1.01) | |
| (See FIGS. 7 and 9) | |
| Wood flour | 60 (wt. %) (American Wood Fibers - |
| | Schofield, Wisconsin) (Pine flour) |
| HDPE | 33.5 wt. % (HDPE) (Chevron 9416, grade |
| | 0.7: Chevron - Houston, TX) |
| Base color | 4 wt. % 20 Melt Index (MI) linear low |
| | density polyethylene - LLDPE) (Penn |
| | Color - Hatfield, PA) |
| Foaming agent | 0.5 wt. % - CT 1153 (now CT 1401) |
| Process Aid | Zinc Stearate - 1.5 wt. % |
| Compatibilizer | 0.5 wt. % AC 540 |
| Sample C | |
| (Density 0.96) | |
| (See FIGS. 7 and 8) | |
| Wood flour | 60 (wt. %) (American Wood Fibers - |
| | Schofield, Wisconsin) (Pine flour) |
| HDPE | 33.5 wt. % (HDPE) (Chevron 9416, grade |
| | 0.7: Chevron - Houston, TX) |
| Base color | 2 wt. % (20 Melt Index (MI) linear low |
| | density polyethylene - LLDPE) (Penn |
| | Color - Hatfield, PA) |
| Chevron 1001 LDPE | 2 wt. % |
| Foaming agent | 0.5 wt. % - CT 1153 (now CT 1401) |
| Process Aid | Zinc Stearate - 1.5 wt. % |
| Compatiblizer | 0.5 wt. % AC 540 |
| Sample D | |
| (Density 1.05) | |
| (See FIG. 8) | |
| Wood flour | 60 (wt. %) (American Wood Fibers - |
| | Schofield, Wisconsin) (Pine flour) |
| HDPE | 33.5 wt. % (HDPE) (Chevron 9416, grade |
| | 0.7: Chevron - Houston, TX) |
| Base color | 2 wt. % 20 Melt Index (MI) linear low |
| | density polyethylene - LLDPE) (Penn |
| | Color - Hatfield, PA) |
| Chevron 1001 LDPE | 2 wt. % |
| Foaming Agent | 0.5 wt. % - Kibbe Chemicals K193LD - |
| | (exothermic) |
| Process Aid | Zinc Stearate - 1.5 wt. % |
| Compatibilizer | 0.5 wt. % AC 540 |

It has been found that using cellulosic material, i.e. wood flour with 4-10 percent weight moisture content in the above process may assist with the process because the moisture may act as a lubricant in the twin-screw extruder 2, though the added moisture is not critical to the invention. Notably, drying the wood flour in the extruder, as opposed to predrying it to less than 1 weight percent moisture, reduces potential explosion hazards.

The above process may be used to form a wood-like decking product comprising a central area with a relatively higher cellulose to polymer ratio and an outer (edge) area with a relatively lower cellulose to polymer ratio. The relative percentages of polymer and cellulose were measured in Sample A with a Fourier transform infrared spectroscopy using an attenuated total reflectance technique and a ZnSe crystal (which penetrates the sample to about 2 to 5 microns). The results were that the ratio of HDPE to cellulose was generally higher in the embossed samples than in the non-embossed samples. Embossed samples were measured near their outer edges and near their core. The ratio of HDPE to cellulose was found to be about 12-13 percent higher at the edges of the samples than in the central area, i.e. the samples had a relatively higher concentration of C—H bonds (associated with polyethylene) near their outer surface and a relatively higher concentration of O—H bonds (associated with cellulose) near their central area. Thus, the extrudate has a very hard, strong, largely polymer outer area and a relatively high cellulose content central area. The result is an extruded product with higher elastic moduli and higher flexural moduli. Thus, this process is particularly advantageous for forming wood-like boards and planks with dense outer areas with less dense inner areas so that strength remains high but with a reduced weight.

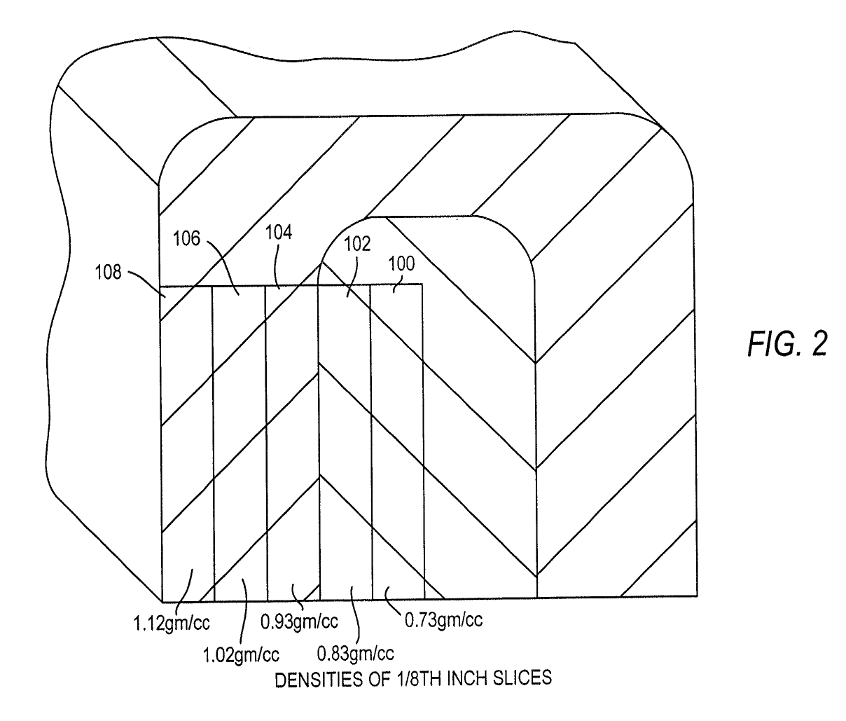

FIG. 2 shows the results of density measurements of portions of a ⅛ inch slice of Sample A outer dimensions 1.125 inches by 5.5 inches). The measurements show that the extrudate has a relatively low density at its most inner portion 100 of 0.73 gm/cc and a relatively higher density at its most outer portion 108 of 1.12 gm/cc. The density was measured at 0.83 gm/cc at the location indicated by reference numeral 102, 0.93 gm/cc at reference numeral 104 and 1.02 gm/cc at reference numeral 106, thus highlighting how the density increases as measurements are taken closer to the outer most portion of the sample. Thus the product is strong due to its dense outer portion but relatively lightweight due to the lower density inner portion. Overall densities of most preferred products may vary between about 0.84 gm/cm³ to 1.12 gm/cm³, though densities lower than 0.84 gm/cm³ and higher than 1.12 gm/cm³ may be achieved.

The process of the present invention may also comprise coextrusion techniques. The use of coextrusion techniques provides for composite materials that are less expensive to manufacture given that one may use more expensive functional additives in the skin and less expensive functional additives in the core. For example, one may use a highly UV-stabilizer in the skin layer to provide long term outdoor protection from ultraviolet degradation and use cheaper recycled or reclaimed polyolefins, unstabilized for the core. Two different techniques are most often employed for coextrusion. In one of these techniques, two or more sheets are extruded from separate extruders through separate sheet dies into contact with one another while still hot and then passed through a single set of rollers or another extrusion die and down a single sheet line. The other coextrusion technique employs an adaptor or other means of bringing two or more different materials from two or more extruders into contact with one another prior to their passage through an extrusion die. Generally, the known coextrusion processes using this technique have employed some form of encapsulation technique wherein one stream of material, typically the volumetrically smaller stream, is completely surrounded, e.g., coaxially, by a second stream of a different material prior to passing the entire composite stream through an extrusion die. Alternatively, such encapsulations may be effected in the cavity portion of the extrusion die itself. In either instance, however, the resulting sheet product is characterized by an inner layer of one type of material sandwiched between or encapsulated by two exterior layers of a second material.

The composite of the present invention may be manufactured using such coextrusion techniques by the following steps: adding the cellulosic material and other ingredients into a first extruder; adding graining color agents near the end of the twin screw extruder; venting the cellulosic material during extruding; adding polymer material to form a cellulosic material-polymer material mixture; extruding the cellulose material-polymer material mixture; repeating the above steps through a second extruder that is combined with the first extruder in a combining adaptor or feedstock; forcing the cellulose material-polymer material mixture through a die to form an coextrudate material with skin and core having different attributes; calibrating the extrudate; and cooling the extrudate to form a polymer cellulose composite.

The process of the present invention may be modified in a manner such that the resulting composite material can be blow molded into containers. Blow molding enhances the versatility of shape and sizes of containers. Blow molded containers may be made from compatibilized wood fiber polymer composites. Several specific conditions need to be met to enable such a blend or composite to be blow molded. Among these are: (i) the moisture level in the composite pellets needs to be below 0.5%, preferably below 0.1% moisture; (ii) the composite blend should exhibit melt elasticity at the temperature of blow molding; (iii) the particle size distribution should be controlled such that the largest particle size is about half the thinnest wall thickness of the bottle or container; (iv) the wood or pulp particles need to be finely dispersed and compatibilized, such that during the blow molding process the melt does not exhibit differential elongation; and (v) the melt viscosity should be sufficiently high and uniform, such that a good parison is formed and during the blowing process the melt has enough melt strength to be able to hold the blowing pressure.

There can be variations in the type and size of fillers and polymer, the percentages used, and processing techniques (monolayer injection, mono/multiplayer extrusion blow molding). Various suitable processing aids and additives may be used, such as ionomer (e.g. Surlyn), internal lubricants (e.g. calcium or zinc stearate), antioxidants, and color concentrates and/or pigments. Based on the final properties of the bottle or container needed, the ratio of the wood fiber may be adjusted from 10% to 70% by weight of the total composite, preferably in the range of 20 to 60% and more preferably in the range of 25% to 50% fiber.

Depending upon the end-use application and the need to reduce the density of the foamed final product, it may be necessary to use two or more combinations of the foaming methods. A preferred embodiment of the invention uses a combination of a mixed exothermic-endothermic blowing agent, a nucleating agent and a physical blowing agent like nitrogen along with the inherent moisture in the wood fiber to evaporate into water vapor or steam. Another preferred embodiment uses a combination of endothermic and exothermic foaming agents. Surprisingly, the use of a combination of endothermic and exothermic foaming agents (e.g. 20 percent exothermic and 80 percent endothermic foaming agents) has been found to result in a product with a lower density core, and reduces carbon monoxide emissions by about 90 percent. Results achieved with just an endothermic foaming agent are often not as good because the melt temperature is lower and density reduction is insufficient. Results with an exothermic foaming agent alone are often not as good because the cellulosic fibers degrade when the melt temperature is greater than about 400° F. In some cases it may be advantageous to use a lower fiber level in order to achieve a lower density of the foamed final product. Using such technique foamed fiber polymer composites of polyolefins in the density range of 0.05 g/cm³ to 1.05 g/cm³ can be prepared. Depending upon the requirements of the specific application, a combination of these foaming techniques enables the specific tailoring of mechanical properties and density for the specific application. The foaming can be achieved at the compounding or the extrusion or molding stage of the process.

Products resulting from the above process have high strength (i.e. high modulus of elasticity) in part because the cellulose fibers are completely encapsulated by the polymer materials due to the good wet-out of the mixture and good bonding between the non-polar polymer and polar cellulose materials, which is improved by the compatibilizer.

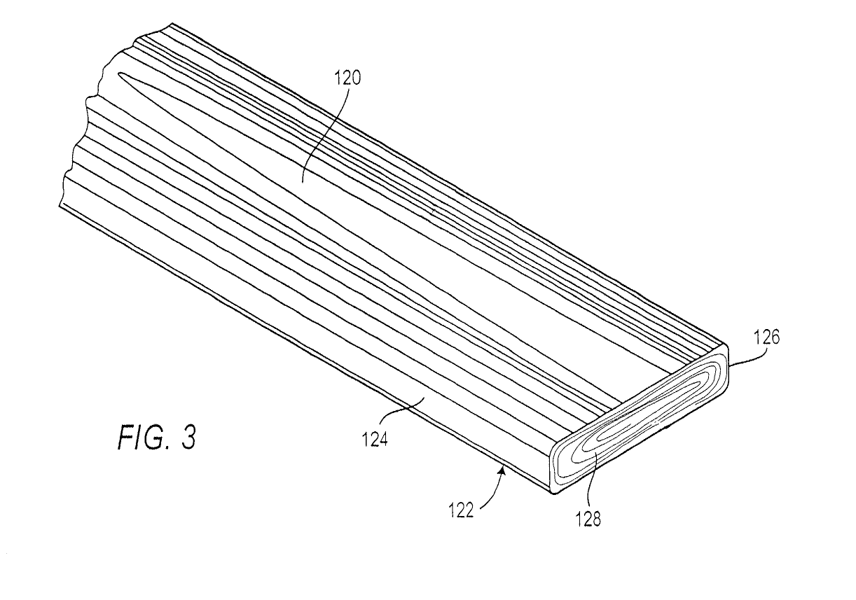

The two-tone color and wood grain appearance of the product resulting from the above process is unique in products comprising non-polar polyolefins compounded with high wood content (i.e., 60 weight percent) and foaming agent because both the cellulose and foaming agent enhance dispersion and generally may ruin the effect. The graining effect throughout the thickness of the board is achieved by adding an additional barrel section 44 to the twin-screw extruder and providing a side feeder just before the discharge end to meter in masterbatch graining colorant pellets. One preferred method for achieving the wood grain effect is achieved by using color masterbatch concentrate pellets with a polyolefinic carrier resin for pigments with lower melt index (or higher viscosity) and higher melting point (140-250 C.) than the base HDPE used as the matrix resin. Alternative methods may include at least (1) metering liquid colorant with a viscosity which is substantially different from that of the cellulose-polymer composite mixture into the single screw extruder, (2) metering masterbatch graining colorant pellets into the barrel section 36 via a side feeder, (3) utilizing an additional small single screw extruder and a specially designed combining adapter with baffle plates at the discharge end of the end of the single screw extruder, to produce a co-extruded profile structure with graining. FIG. 3 shows how a two-tone finish and three-dimensional embossing may be combined so that the extrudate appears like real wood. All sides of the decking product show a two-tone wood grain color and in this embodiment the top 120 and the bottom 122 of the decking product are embossed with a texture finish that adds to the overall wood-like appearance. Sides 124 and 126 do not need to be embossed because those surfaces normally would not be visible after construction. The grain-like appearance at the board end 128 is visible wherever the board is cut, as it would be in a real wood plank.

The above described method of achieving wood grain is applicable to both single pass direct profile application, as detailed above, and a two pass process in which the initial stage is pelletizing in a larger compounding twin screw extruder followed by a number of smaller single or twin screw extruders to make the final product. Products may be embossed with a dual roll embosser. The embosser comprises top and bottom rolls, for example, hardened stainless steel tubing with a chrome finish, and a temperature control.

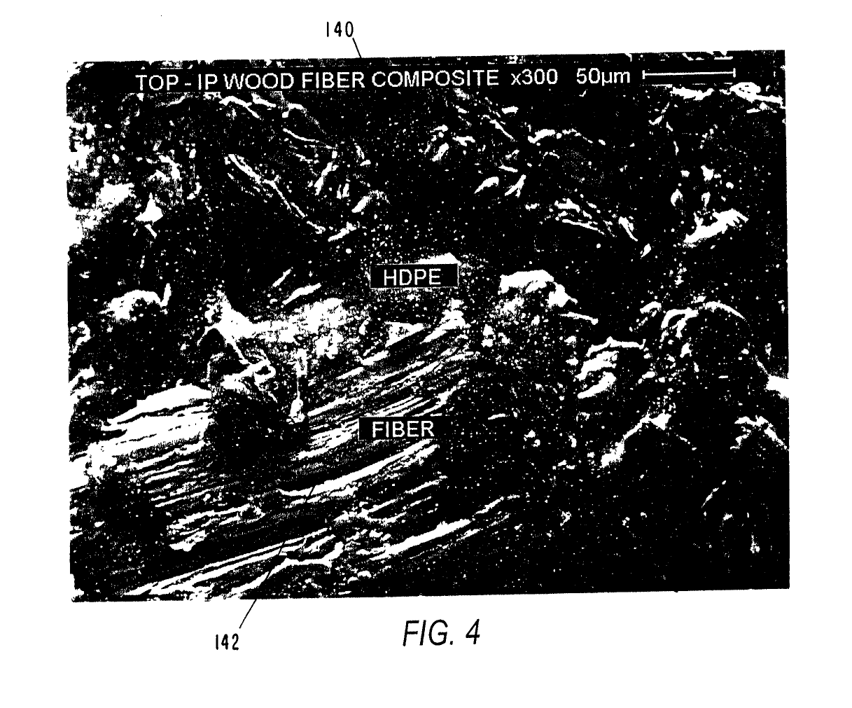

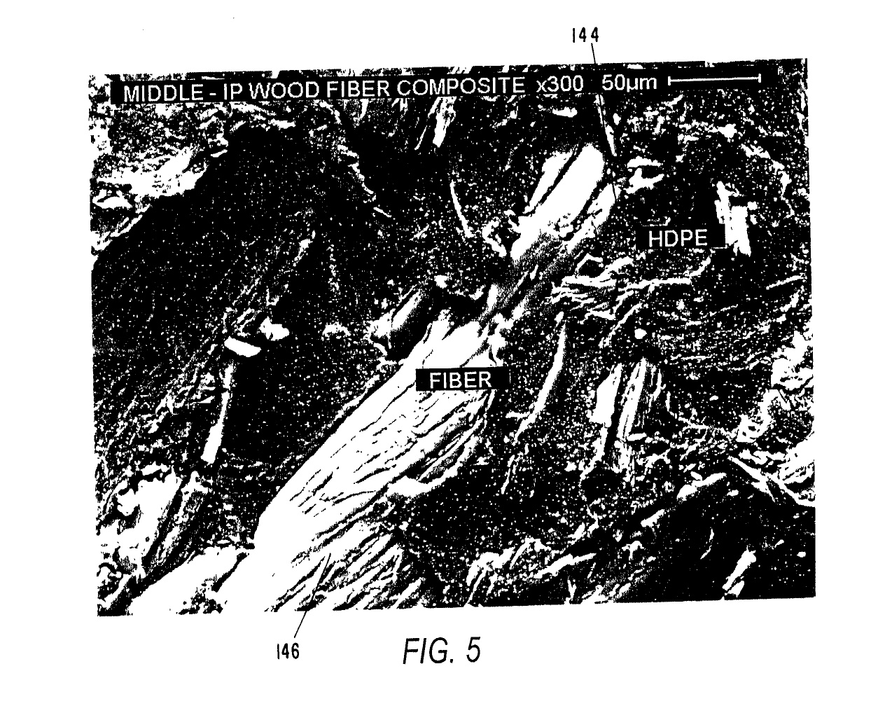

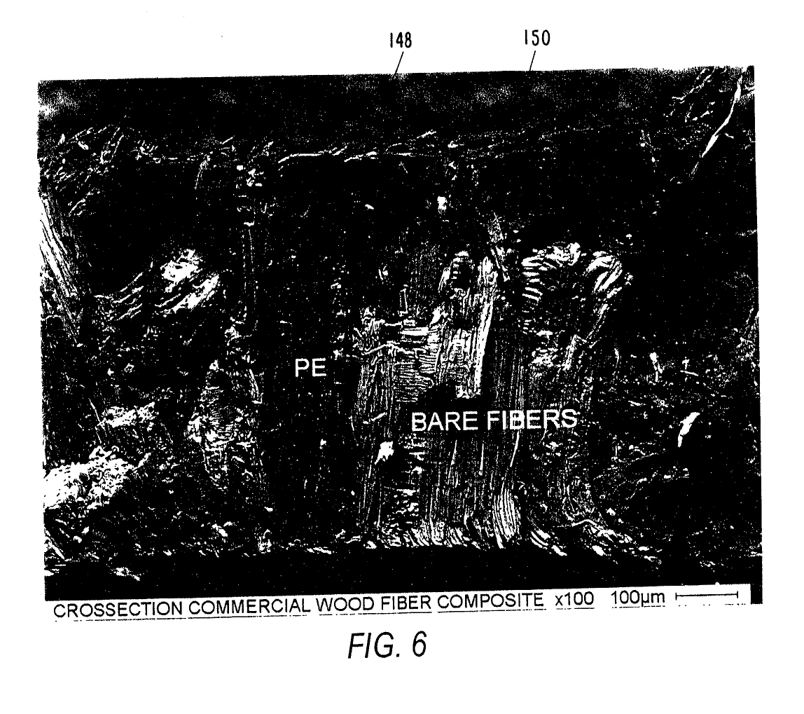

FIGS. 4 and 5 are scanning electron micrographs of Sample A and FIG. 6 is a scanning electron micrograph photomicrograph of a commercially available product (TREX EASY CARE®). All photomicrographs are of materials fractured after treatment with liquid nitrogen. The fracture procedure was used because a traditional sawing process may have scattered or smeared the polymer or cellulose components, potentially altering the quality of the samples.

Specifically, FIG. 4 is a photomicrograph showing a portion of a cross-sectional slice of Sample A, viewing an area near an outer edge of the cross section at 300× magnification, which shows substantially complete encapsulation of cellulosic material 142 by polymeric material (high density polyethylene) 140. FIG. 5 is a photomicrograph showing a portion of a cross-sectional slice of Sample A, viewing an area near a central portion of the cross section at 300× magnification, which shows substantially complete encapsulation of cellulosic material 146 by polymeric material (high density polyethylene) 144. FIG. 6 is a photomicrograph of a portion of a cross-sectional slice of TREX EASY CARE® at 100× magnification, which shows cellulosic material 150 which is not fully encapsulated by polymeric material (polyethylene) 148. The complete encapsulation of the cellulosic material shown in FIGS. 4 and 5 is achieved by adding the additives (compatibilizer and process aid) at an appropriate location (high shear location) in the extrusion process.

FIGS. 7, 8 and 9 show the results of comparative tests, which were conducted between several sample products and several commercially available products.

FIG. 7 shows a comparison of the modulus of elasticity vs. temperature of Samples B and C as compared to TREX EASY CARE® (Commercial 1), SMARTDECK® (Commercial 2) and CHOICEDEK® (Commercial 3). Both Samples show a relatively high modulus of elasticity, i.e. strength, over a variety of temperatures.

FIG. 8 shows a comparison of the force required to withdraw a nail (6 penny) from Samples C and D as compared to TREX EASY CARE® (Commercial 1), SMARTDECK® (Commercial 2) and CHOICEDEK® (Commercial 3). The results show that both Samples have high fastener retention, which is desirable in construction applications.

FIG. 9 shows a comparison of the static coefficient of friction of Sample B as compared to TREX EASY CARE® (Commercial 1) and SMARTDECK® (Commercial 2). Sample B has relatively high static coefficients of friction. In the case of a decking product, this translates into a less slippery walking surface.

Table 3 is a glossary of the manufacturers and composite materials, which were tested and compared in FIGS. 7, 8 and 9.

Table 4 shows the physical and mechanical properties of composition C.

TABLE 3
GLOSSARY OF PRODUCTS TESTED

| | |
|---|---|
| CHOICEDEK ® | AERT, Inc. |
| | (Springdale, Arkansas) |
| TREX EASY CARE DECKING ® | Trex Co. LLC |
| | (Winchester, Virginia) |
| SMARTDECK ® | US Plastic Lumber |
| | (Boca Raton, Florida) |

TABLE 4
Some of the Physical and Mechanical Properties

| PROPERTY | VALUE |
|---|---|
| Density | 0.96 |
| Modulus of Elasticity | |
| 32*F | 390000 psi |
| 74*F | 293239 psi |
| 100*F | 220000 psi |
| 150*F | 191994 psi |
| Coeff. Of Friction | |
| Dry | 0.53 |
| Wet | 0.83 |
| Coeff. Of Thermal Expansion | 0.0000171 in./in./*F |
| Thickness swell | 0.5 |
| Nail Withdrawal | 130 lbs/in. |
| Screw Withdrawal | 410 lbs/in. |

There are a multitude of variations, which may be made to the processes described above. For example, batch blending can be utilized in place of the loss in weight feed system. Batch blending involves premixing additives and then conveying the mixture to the compounding extruder. However, losses in weight feeders, which accurately meter each ingredient directly into the compounding extruder, are preferred because the use results in a more consistent product formulation. Further, loss in weight feeders allow for easy product formulation changes and allow different product formulations to be run on different extruders simultaneously. Both methods are well known within the art.

Further, the process may be carried out without the twelfth barrel section 46. However, barrel section 46 allows the coloring agents to mix more thoroughly throughout the thickness of the profile so the final product has, overall, a more uniform two-tone grain coloration.

Another alternative is forming pellets, rather than extrudates such as boards, from the process. When practicing this method it is important to maintain the temperature in the extruder 2 as well as the pelletizing die and pelletizer (not shown) and profile die 54 below about 400° F. to prevent thermal degradation of the cellulosic fibers. The resulting pellets, which can be of any desired size depending on the openings in the pelletizer and the operating speed of the cutter, are recovered for further processing as will be described below.

The composite pellets can be injection molded, blow molded or extruded into various shapes and articles for various end-use applications. In the case of blow molding the compounded pellets can be further blended with neat fractional melt (melt index in the range of 0.2-0.9 dg/min) or high load melt index (HLMI) of 2 to 20 high-density polyethylene resin. In extrusion blow molding pellets are melted, formed into a tubular parison or preform which is blown into the final shape against he walls of the mold cavity. The part is cooled in the mold using air or a cold gas. After cooling, the two mold haves separate, and the part is ejected. In the case of injection molding, the pellets are melted and injected into a closed cavity, cooled and then ejected. For injection molding grades the melt index or flow rate of the compounded pellets is adjusted to between 3 and 200 dg/min, preferably between 5 and 30 dg/min. In the case of profile extrusion the compounded pellets would have a melt index or melt flow rate in the range of 0.1 to 10 dg/min, and preferably in the range of 0.3 to 4 dg/min

There are a wide variety of materials and percentages of said materials that may be utilized in the invention. Many embodiments of the invention comprise a high percentage of cellulosic material in the form of wood flour, i.e. in excess of about 55 percent by weight, yet can still be extruded into desired shapes with wood grain, texture and reduced density and with superior physical properties. The subject compositions are generally comprised of at least about 50 percent, preferably from about 55 to about 68 percent by weight of wood flour, generally not more than about 3 percent, preferably from about 0.25 to about 2.0 percent by weight of a suitable compatibilizer, generally not more than about 50 percent, preferably from about 16 to about 50 percent by weight of a thermoplastic resin component, and up to about 15 percent by weight of conventional additives such as processing lubricants, foaming agents, preservatives, flame retardants, process and UV stabilizers, color pigments and the like. In addition, mineral fillers, such as mica and talc, flexomers such as metallocene polyolefins having low crystallinity, ethylene-propylene rubber, and other elastomers may be added to the composition to affect the rigidity and strength of the final product.

The cellulosic fiber component of the subject compositions may be comprised of wood pulp or flour, sawdust, paper mill and lumber mill waste and the like, and can be hardwood, softwood or mixtures thereof. Various raw materials can include at least sawdust from lumber mills, wood flour from chips and planer shavings, primary effluent or sludge, secondary effluent or sludge, fiber fines, pulp fines, ground and dried fiber, kraft, cardboard and corrugated scrap, coated brown corrugated and uncorrugated board and kraft paper scrap, disc-ground dried fluffy wood fiber used in a sealed press or other process, newsprint scrap and newspaper, newspaper and paper clippings and office paper scrap and coated cupstock and waste polycoated paper and paperboard..

Preferably, cellulosic fibers should have low moisture content, preferably less than about 10 percent by weight, most preferably 4-10 percent, and a specific particle size distribution.

Methods for preparing composites made from waste polycoated paper and paperboard may include the following steps: (i) subjecting the waste coated paper and/or paperboard to a size reduction treatment for a sufficient time to breakdown the coated paper or paperboard to small particles, the particle size and size distribution being dictated by the need of the particular end-use application: (ii) melt mixing or compounding the particles with more plastic or polymer in a compounding extruder or melt mixer to form composite pellets; (iii) the composite pellets can then be converted to useful packaging articles such as cups, plates, trays, clamshells, lids, by known methods, including but not limited to extrusion, profile extrusion, sheet extrusion followed by thermoforming, injection molding or any combination thereof. If instead of industrial scrap and waste, the coated paper and paperboard is post-consumer, other articles may be manufactured, for example, packaging materials for health and beauty, chemicals, fertilizers and other non-food materials.

Coated paper and/or paperboard usually contain a coating of extruded polyethylene and occasionally some other polymers such as ethylene copolymers, nylon or ethylene vinyl alcohol copolymer (EVOH) in the ratio of about 5 to 20% polymer by weight and typically around 10% polymer by weight. Thus, depending on the end use application and the end performance needed in terms of mechanical properties, the ratio of the shredded polycoated board to more polyethylene can be adjusted, so that the fiber contents is in the range of 20 to 80%, preferably in the range of 30 to 70% and more preferably 30 to 60%. Optionally a compatibilizer can be added at a level of 0.5 to 30% and preferably in the ration of 1 to 10%.

Appropriate resins include at least thermoplastic polyolefins such as homopolymers and copolymer of polyethylene, polypropylene, polystyrene and polyvinyl chloride having densities in the range of 0.85-1.4 g/cm³ (as used herein: grams/cubic centimeter is equivalent to g/cm³ and gm/cc) and melt indices in the range of 0.1-200 dg/min. The resin component may include post-industrial and post-consumer recycled reground resin flakes or pellets as well as virgin prime resins. Those of ordinary skill in the art will appreciate that it is possible to blend a number of resin sources, both recycled and virgin resins, having different melt indices to achieve the final desired melt index for inclusion in the subject compositions. Depending on the downstream process requirement and the final shape of the finished article, it may be necessary to vary the viscosity of the composition to achieve a balance of optimum process efficiency, aesthetics of the final part and mechanical properties. For example, with profile and sheet extrusion typically the melt index for polyethylene based or polypropylene based compositions should be in the range of 0.5 to 5 dg/min, most preferably in the range of 0.5 to 2.5 dg/min. For injection molding preferably in the range of 3.0 to 50 dg/min and most preferably between 5 to 30 dg/min, depending on the final part thickness, shot size, design of the mold and other considerations.

Appropriate compatibilizers may include a copolymer of ethylene or propylene having pendant carboxylic acid and/or grafted acrylic acid or anhydride groups that react with free hydroxyl groups on the cellulosic fibers. Such compatibilizers are formed by grafting organic anhydrides such as maleic anhydride and phthalic anhydride or acid functionality onto polyolefin homopolymers. These are well-known copolymers and are commercially available, for example, from Honeywell (Morristown, N.J.) as A-C® 573 and 575 (maleated polyethylene) and A-C® 596, 597, 1221 and 950 (maleated polypropylene), or A-C® 540, 540A, 580, 5120 (ethylene acrylic acid copolymer), from Crompton Knowles Witco (Greenwich, Conn.) as POLYBOND® 3000 or 1000; from Eastman Chemicals (Kingsport, Tenn.) as EPOLENE® C-16, C-18 (both polyethyene based) and E-43, G-XX01, G3003 and G-XX15 (all PP-based) or ethylene-acrylic acid copolymers, sold under the trade name PRIMACOR® from Dow Chemicals (Midland, Mich.) or ethylene methacrylic acid copolymers such as NUCREL® from DuPont(Wilmington, Del.). Terpolymers of ethylene, an unsaturated ester such as methyl acrylate and acrylic acid or maleic anhydride can also be used as compatibilizers. Examples of these are Lotader 2210 and 3410® from Atofina (Philadelphia, Pa.) and some of the BYNEL® grades from DuPont. Such copolymers and other compounds containing pendant active groups such as anhydride or acid moieties are also referred to in the art as coupling agents. Suitable compatibilizers based on polyethylene and polypropylene generally have a molecular weight of about 2,000-200,000 and a saponification number of 3-120 mg KOH/g and a density of 0.9-0.96. Preferred viscosity ranges are 200 to 500,000 cP.

The amount of compatibilizer needed to achieve the appropriate wetting of the cellulose fiber depends on the fiber loading, surface area of the fiber, and the amount of active functional groups in the compatibilizer. For each composition the optimum level is determined empirically. The amount of compatibilizer used is preferably from 0.1 percent to 10 percent, more preferably 0.25 to 2 percent of the total weight of the composition.

A significant advantage of the compositions of the invention is that they may be combined with various additives before being fabricated into shaped articles while maintaining their strength and other attributes. Additive type and amounts generally depend by the type of article that is to be made and requirements related to rigidity, color, flexibility, strength, impact resistance and the like. Such additives may include flexomers, mineral and/or glass fibers, additional compatibilizers, UV absorbers, hydrophobic molecular sieves, other resins and the like.

Additives used to modify the density and mechanical properties of the composition are mineral additives and flexomers commonly known to those skilled in the art. Physical foaming agents include gases such as compressed air, carbon dioxide, nitrogen, argon, helium, hydroflourocarbons and other gases injected into the melt. Chemical foaming agents can be exothermic, endothermic or combinations thereof. Some examples of chemical foaming agents include such as sodium bicarbonate, azodicarbonamide, modified azodicarbonamide, p-toluene sulfonyl hydrazide, or p,p-oxybis benzene sulfonyl hydrazide with or without the use of an activator such as zinc oxide. These agents may, as an example, be used at a ratio of 0.01 to 40 weight percent based on the dry weight of the total polymeric resin. Mineral additives suitable for increasing the rigidity of these composites of this invention may include at least mica, talc, calcium carbonate, glass fiber, glass beads, glass flake, wollastonite, and the like. Among the flexomers suitable for increasing flexibility and the low temperature impact strength are ethylene-propylene rubber (EPR and EPDM), polyisobutylene, metallocene polyolefins with low or no crystallinity. Additives to enhance insect resistance, scratch resistance and self-cleaning qualities may also be included. The amount and type of additives used is generally governed by the properties desired in the final product.

A variety of other additives may also be used and some, such as preservatives and internal processing lubricants, may be included in the initial blend and formed into pellets as described above. Other additives may be added to the pellets generally when they are conventionally processed into finished articles, such as flame retardants, e.g. polyethylene based FRYEBLOC® (Great Lake Chemicals) and ethylene vinyl acetate based ENVIROSTRAND® (Great Lake Chemicals), at about 3 to 6.5 percent by weight; insecticides and/or fungicides, such as BOROGARD® (Borogard), which is a combination of zinc oxide and boric oxide, preferably utilized at a concentration of about 0.75 percent by weight; thermal and ultraviolet stabilizers, such as IRGANOX 1010® (Ciba Specialty Chemicals) and other suitable hindered phenol antioxidants or IRGAPHOS® (Ciba Specialty Chemicals) and other phosphorus-based agents which are typically present at 0 to 1 percent, preferably 0.01 to 0.5 percent, by weight; TINUVIN 791® and TINUVIN 783®, hindered amine light stabilizers and other ultraviolet stabilizers which are available from Ciba Specialty Chemicals (Tarrytown, N.Y.) are preferably used at a range of 0 to 1 percent, more preferably 0.1 to 0.5 percent, by weight, depending on the extent of UV protection needed; process lubricants, such as calcium or zinc stearate, an ester or bistearamide waxes can be used up to about 2 percent by weight; pigments and acid neutralizers, such as stearate-coated hydrotalcite (aluminum-magnesium hydroxide carbonate hydrates) are preferably at 200-800 ppm levels to neutralize any acidity present and to improve melt flow.

A large variety of products may be made from the composites. Some examples include various articles for packaging such as injection molded single serve containers, returnable tote bin containers, CD, DVD and extruded and injection molded articles for the building industry, including decking panel boards, end-caps, deck railing and other components for the decking system, skirting and molded parts for manufactured housing, door and window parts, water-proof boards for the do-it-yourself market, hollow molded doors, bathroom and under-sink water-proof cabinet parts, siding, fencing, roofing, door skins, flooring tiles, acoustic panels, deck railing components, spindles, posts, post wraps and fascia. In some products, a UV-stabilized outer layer may be combined with a lower cost inner layer without UV protection. This is particularly effective for polypropylene, which has lower resistance to UV degradation compared to, for example, polyethylene.

Compatibilized blend of wood fiber/flour and thermoplastic polymers may be prepared by melt compounding of wood flour/fiber into a tailored mix of polymer resin to form composites. The composites may then be converted into application for materials.

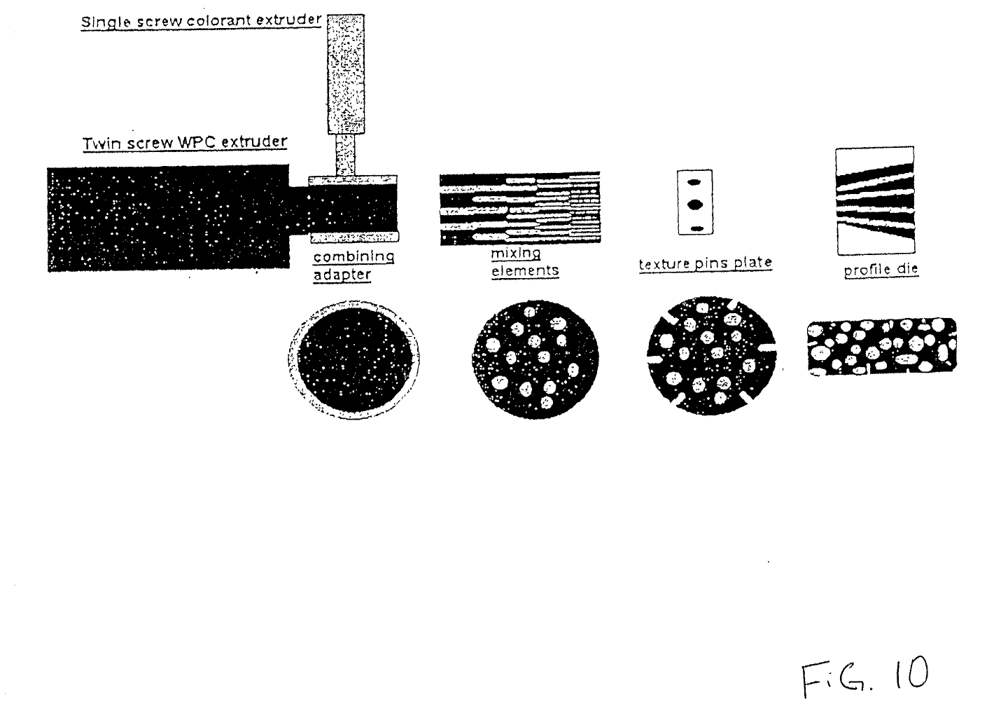

For making decking panels, composite pellets made during the compounding stage are dried to a moisture content<0.7 wt % and then fed into the hopper of a single screw or twin screw extruder and conveyed through a profile die (FIG. 10) having dimension of the finished product. For decking application one may use coextrusion technique whereby the core layer comprises 50-60 wt. % filler and a capstock with 10-30 wt. % filler.

### EXAMPLE 1

In compounding, the first step involves pre-blending dried (in the range 0.1 to 10%, preferably below 5% moisture) wood flour and/or pelletized fiber with a compatibilizer such as polyethylene or polypropylene grafted with acrylic acid or maleic anhydride or other suitable functional group and a process lubricant such as zinc or calcium stearate using a Gelimat, Henschell or a Banbury mixer. If wood fibers are used they are pelletized using a pellet mill or other suitable equipment. A thermoplastic polyolefin having density in the range of 0.88-0.97 g/cm³ and melt index or melt flow rate in the range of 0.1-40.0 dg/min. may also be added at this step. Depending upon final application and desired properties, pellets of either polypropylene (PP) resin or high density polyethylene (HDPE) having a melt index of<1.0 are mixed with copolymer PP or HDPE resin pellets respectively with melt index in the range of 20-35 in a ratio of 4:1 or more preferably in the ratio of 3:1. This is then gravimetrically fed into a co-rotating or counter-rotating twin-screw extruder of a Banbury mixer or a Buss Kneader or a Farrel continuous mixer (FCM). A single screw extruder may be used if it is fitted with the right screw profile to give distributive mixing and venting when necessary. The pre-blend of the wood fiber/compatibilizer/lubricant is then introduced downstream into the molten resin via a side stuffer. To avoid any thermal degradation of the cellulosic fiber, the temperature along the screw profile in the different zones (feed, melting and melt convey) and the strand die is kept below 200° C. The molten mix after exiting the strand die forms several composite strands which are then passed through a hot face or an under water Gala pelletizer, whereby composite pellets with about ⅛″- 3/16″ diameter are obtained. Alternative methods of pelletization such as sheet formation followed by dicing, water-ring pelletization, or strand cutting followed by drying can also be employed.

### EXAMPLE 2

Pellets of high density polyethylene with a melt index of<1.0 dg/min. are gravimetrically fed into a co-or counter-rotating twin screw extruder. The pre-blend of the wood fiber, compatibilizer and other additives such a flexors, antioxidants, odor absorbants, and color concentrate is then introduced downstream into the molten resin via side stuffer. Alternatively, these additives and the compatibilizer may be introduced in with the resin in the main hopper. The temperature along the screw profile in the different zones (feed, melting and melt convey) and the strand die is kept below 200° C. to avoid any thermal degradation of the wood fibers. The strands are cooled using water or more preferably air, and then passed through a pelletizer, whereby pellets of the composite are obtained. The composite pellets can then be extrusion (continuous or intermittent) or injection blow molded as is or blended with neat fractional melt (melt index in the range of 0.2-0.9) or high load melt index (HLMI) high-density polyethylene resin. In both injection and extrusion blow molding, the pellets are melted, formed into a tubular parison or perform, which is blown into the final shape against the walls of the mold cavity. The part is cooled in the mold using air or a cold gas. After cooling, the two mold halves separate, and the part is ejected.

### EXAMPLE 3

The exothermic chemical blowing agent Azodicarbonimide, CELOGEN 754-A (obtained from Uniroyal) at a ratio of 1.5% was introduced downstream, while 38% HDPE, 0.9 MI and a density of 0.961 (DMDH 6400 obtained from Union Carbide) 60% wood flour 40 mesh hardwood from American Wood Fibers, and 2% compatibilizer (AC573 obtained from Allied-Signal Chemicals) and 0.05% calcium stearate all percentages expressed as w/w) were introduced into the extruder in the main hopper except for the wood fiber which was introduced with a side feeder into the melt. Rectangular panels of 1″ by 4″ cross sections were obtained with about 20% reduction in density as compared to a similar formulation without the chemical blowing agent.

Although the invention has been described with reference to preferred embodiments, it will be understood by those skilled in the art that various changes may be made and equivalents may be substituted for elements thereof without departing from the scope of the invention. Therefore, it is intended that the invention not be limited to the particular embodiments disclosed as the best mode contemplated for carrying out this invention, but that the invention will include all embodiments falling within the scope and spirit of the invention as defined in the appended claims.

What is claimed is:

1. A composite comprising polymer material, the composite having a core layer comprises of 50-60 wt. % filler and a capstock with 10-30 wt % filer

2. The composite of claim 1, wherein the composite has a wood grain coloring.

3. The composite of claim 1, wherein the composite has a three dimensional embossed wood-like texture.

4. The composite of claim 1, further comprising compatibilizers, process aids, foaming agents, coloring agents, UV inhibitors and flame retardants.

5. The composite of claim 1, further comprising a foaming agent, the foaming agent comprising about 20 percent exothermic foaming agent and about 80 percent endothermic foaming agent.

6. The composite of claim 1, further comprising a compatibilizer.

7. The composite of claim 1, further comprising ethylene acrylic acid copolymer.

8. The composite of claim 1, wherein a final product formed of the composite is selected from the group consisting decking, panels and sheets.

9. The composite of claim 1, wherein the polymer material comprises at least some recycled matter.

10. A process for preparing polymer-cellulose composites, which composite comprises a core layer comprises of 50-60 wt. % filler and a capstock with 10-30 wt % filer which process comprises the steps of:
(a) adding the cellulosic material into a first extruder;
(b) venting the cellulosic material during extruding;
(c) adding polymer material to form a cellulosic material-polymer material mixture;
(d) extruding the cellulose material-polymer material mixture;
(e) repeating steps (a)-(d) through a second extruder that is combined with the first extruder in a combining adaptor;
(f) forcing the cellulose material-polymer material mixture through a die to form an coextrudate material with skin and core having different attributes;
(g) calibrating the extrudate; and
(h) cooling the extrudate to form a polymer cellulose composite.

11. The process of claim 10, wherein the polymer material further comprises a chemical selected from the group consisting of compatibilizers, process aids, foaming agents, coloring agents, UV inhibitors and flame retardants.

12. The process of claim 1, wherein step (c) further comprises:
(a) adding a coloring agent to the cellulose material-polymer material mixture, and (b) coextruding the cellulose material-polymer material mixture with the coloring agent.

13. The process of claim 10, wherein the process further comprises embossing the extrudate.

14. The process of claim 10, wherein the coextrudate that is formed by the die in step (f) is substantially rectangular in shape.

15. The process of claim 10, wherein the composite has a wood grain coloring.

16. The process of claim 10 wherein the composite has a three-dimensional embossed wood-like texture.

17. The process of claim 10, further comprising a foaming agent, the foaming agent comprising about 20 percent exothermic foaming agent and about 80 percent endothermic foaming agent.

18. The process of claim 10 wherein a final product formed of the composite is selected from the group consisting decking, panels and sheets.

19. The process of claim 10, wherein the polymer material comprises at least some recycled matter.

20. The process of claim 19 wherein the recycled matter is waste of poly-coated paper and paperboard.

21. The process of claim 10 wherein the composite material is blow molded into containers.

22. The process of claim 15 wherein the wood grain effect is achieved by using color masterbatch concentrate pellets with a polyolefinic carrier resin for pigments with lower melt index (or higher viscosity) and higher melting point (140-250 C.) than the base HDPE used as the matrix resin.

23. The process of claim 15 wherein the wood grain effect is achieved by metering liquid colorant with a viscosity which is substantially different from that of the cellulose-polymer composite mixture into the single screw extruder; metering masterbatch graining colorant pellets into the barrel section 36 via a side feeder, and utilizing an additional small single screw extruder and a specially designed combining adapter with baffle plates at the discharge end of the end of the single screw extruder, to produce a co-extruded profile structure with graining.
